(19) United States
(12) Patent Application Publication
(10) Pub. No.: US 2010/0147314 A1
(43) Pub. Date: Jun. 17, 2010

(54) SYSTEM AND METHOD FOR PROVIDING BODY TREATMENT

(76) Inventor: Kevin Lees, Gilbert, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 12/639,833

(22) Filed: Dec. 16, 2009

Related U.S. Application Data
(60) Provisional application No. 61/138,019, filed on Dec. 16, 2008.

(51) Int. Cl. A61G 15/12

(52) U.S. Cl. 128/845

(57) ABSTRACT

A body treatment system and method that facilitates positioning of a patient's body in order to provide treatment. The body treatment system may include a frame, seat, chest support and back support component to target and stabilize specific regions of interest on a patient's back. The frame is adjustable to allow a user to move the components of the system to a desired position. The seat position may be independently adjusted at one or more corners or sides to facilitate treatment.

### CROSS-REFERENCE TO RELATED APPLICATIONS

This application claims priority to U.S. Provisional Application Ser. No. 61/138,019, filed on Dec. 16, 2008 and entitled “SYSTEM AND METHOD FOR PROVIDING BODY TREATMENT,” which is incorporated herein by reference in its entirety.

### FIELD OF THE INVENTION

This disclosure generally relates to systems and methods for providing treatment to one or more areas of a body, such as a back, shoulders, and/or neck of a human body.

### BACKGROUND

Various systems and methods for providing chiropractic treatment are known. For example, tables are commonly used in the chiropractic art to suspend a patient while performing lumbar decompression and traction.

However, one disadvantage of using conventional chiropractic tables is that they provide traction over a general area rather than providing targeted stabilization to a specific region of interest, such as one or more vertebrae. Moreover, receiving treatment in a prostrate position rather than from a seated or standing position may be uncomfortable for the patient.

As such, improved body treatment systems and methods providing targeted stabilization of a region of interest to facilitate treatment of a patient in a seated or standing position are desired.

### SUMMARY

Although the methods and systems of the present disclosure may be capable of alleviating some or all of the disadvantages discussed above, it will be appreciated that other disadvantages may be alleviated as well. While the way in which the subject of the present disclosure addresses disadvantages will be discussed in greater detail below, in general, the present disclosure is intended to provide a system and method that facilitates chiropractic treatment of a targeted region of interest from a seated or standing position.

In accordance with an exemplary embodiment of the invention, a body treatment system comprises a frame, a seat, a chest support and a back hold. Each component or a variety of the components may be adjustable to fit the dimensions of a patient and/or be adjustable to provide treatment to the patient. The system may also comprise any number of other components that may aid in treatment, comfort, or safety such as chest, abdomen, knee, arm, hand, and/or face support components.

The body treatment system may comprise one or more adjustment mechanisms to permit a user to adjust the position of the components of the system to fit the size and shape of the patient. Any or all of the support components may be locked in a fixed position or may be operable to adjustably rotate, slide or otherwise move to a desired position to enhance patient comfort and/or treatment. Furthermore the support components may be removable from the system to allow for a variety of treatments and procedures.

In accordance with various aspects of this exemplary embodiment, the chest support and back are designed to restrain a torso of a patient while the seat is moved relative to the chest support and back hold, allowing a targeted area of the back of the patient to be placed in traction or otherwise manipulated.

The seat may be any structure suitable to support a patient in a seated position. The seat may be internally adjustable. The seat may also have suitable brackets and features to interact and be adjustable relative to other components and/or the seat may also be removable or absent from the system. The body treatment system configured without the seat component may be optimized to allow a patient to receive treatment from a standing position.

The chest support may be any structure suitable to support a front side of an upper torso of a patient in a seated or standing position. The back hold may be rigid to supply pressure to specific regions or areas of the chest and/or it may be padded to provide comfortable stabilization.

The back hold or back stabilization component may be any device which stabilizes the position of all or a portion of a patient's back to provide treatment. The back hold may be configured, to work with the chest support to provide sufficient force to act as a fulcrum to the rest of the body allowing the portion of the patients back to remain stationary during treatment. The back hold may be rigid to supply pressure(s) to specific areas or regions of the back and/or it may be padded to provide comfortable stabilization.

In accordance with another exemplary embodiment, a method for providing a body treatment may comprise positioning a patient within a body treatment system adjusting the position of a back hold to at least one of an appropriate height, depth and angle to contact and/or target a desired region of interest on a patient's back; and performing treatment on a patient. The method may further comprise treating a patient by adjusting an angular, horizontal and/or vertical seat position relative to a chest support and back support while the patient is seated in the treatment system. The treatment may comprise placing a targeted portion of the back of the patient in traction.

### BRIEF DESCRIPTION OF THE DRAWINGS

Additional aspects of the present invention will become evident upon reviewing the non-limiting embodiments described in the specification taken in conjunction with the accompanying figures, wherein:

FIG. 1 illustrates a side view of a body treatment system in accordance with an exemplary embodiment of the invention;

FIG. 2 illustrates a perspective view of a body treatment system in accordance with the exemplary embodiment of the invention illustrated in FIG. 1;

FIG. 3 illustrates a front perspective view of a seat component in accordance with an exemplary embodiment of the invention;

FIG. 4 illustrates a perspective view of a body treatment system in accordance with another exemplary embodiment of the invention;

FIG. 5 illustrates a side view of a body treatment system in accordance with the exemplary embodiment of the invention illustrated in FIG. 4; and

FIG. 6 illustrates another side view of a body treatment system in accordance with the exemplary embodiment of the invention illustrated in FIG. 4.

### DETAILED DESCRIPTION

The following description is of exemplary embodiments of the invention only, and is not intended to limit the scope, applicability or configuration of the invention in any way. Rather, the following description is intended to provide a convenient illustration for implementing various exemplary embodiments of the invention. As will become apparent, various changes may be made in the function and arrangement of the elements described in these embodiments without departing from the scope and spirit of the invention.

That said, a system and method for providing body treatment is provided. A body treatment system in accordance with various exemplary embodiments of the present invention may comprise any device, apparatus or structure that permits a user to position all or a portion of a patient's body position to provide treatment. The system may be used to provide treatment to any area of the body, including for example, a back, shoulders and/or neck of a human body.

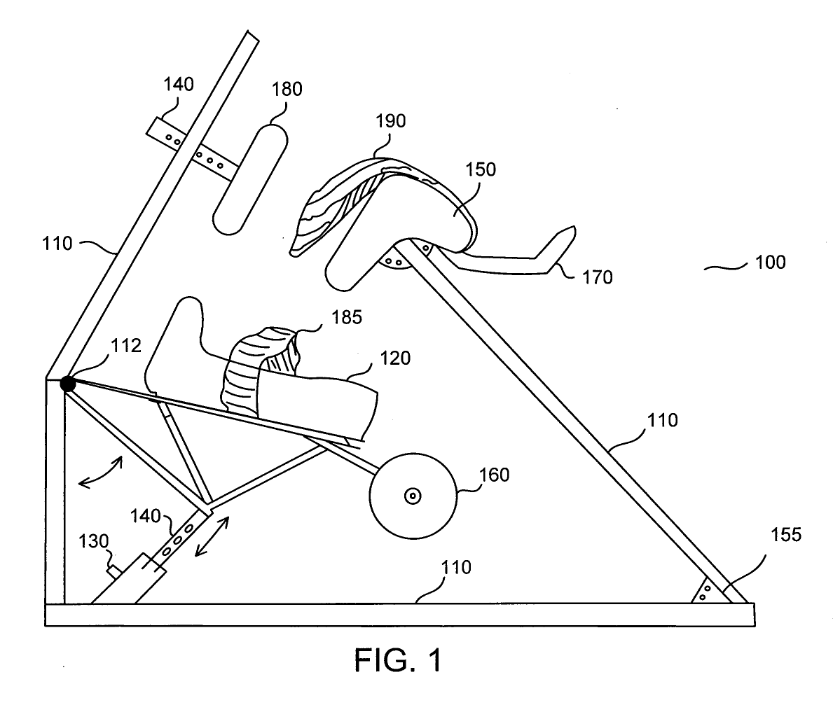

In accordance with various exemplary embodiments of the present invention, and referring to FIG. 1, a body treatment system 100 includes a frame 110, a chest support 150, a back hold 180 and optionally a seat 120.

Frame 110 may be any vertical, horizontal, or angular structural member configured to support seat 120, back hold 180, and chest support 150. Frame 120 may be tubular or solid. In accordance with one embodiment, frame 150 may comprise a lightweight material such as aluminum and/or plastic. However, any sufficiently rigid material such as steel, metallic alloys, wood and/or the like may be used.

In accordance with one exemplary embodiment of the present invention, still referring to FIG. 1, body treatment system 100 may also include additional components to provide support and/or stabilization for various regions of the body. For example, other support and/or stabilization devices may include, but are not limited to, a leg support 160, a hand support 170, a lap safety harness 185, and an upper body safety harness 190.

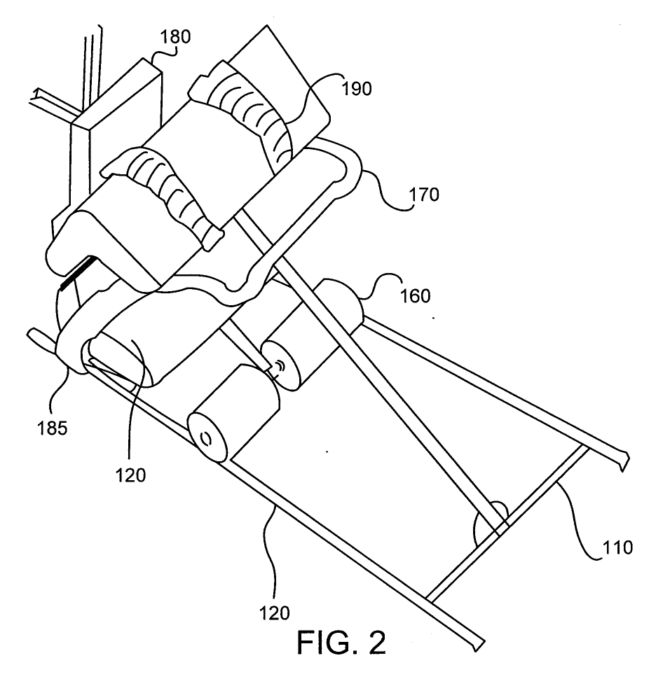

As illustrated in FIGS. 1 and 2, body treatment system 100 may include lap safety harness 185 operable to fasten around a patient's thighs and upper body safety harness 190, which may be looped under each arm of a patient and around the patient's back. In one exemplary embodiment, upper body safety harness 190 may drape over chest support 150 and attach to either chest support 150 or frame 110. Upper body safety harness 190 may be configured to hold the patient against the chest support during treatment. In one exemplary embodiment lap safety harness attaches to seat 120 and is configured to hold a patient against the seat during treatment.

Furthermore, in accordance with various embodiments of the invention, a safety harness such as lap safety harness 185 and/or upper body safety harness 190 may include a strap, belt, harness, thigh brace, rib brace, back brace, or any other mechanism which may be used to further stabilize and secure a patient's body position during treatment. For example, upper body safety harness 190 may include a fastening and/or tightening mechanism configured to pull the patient to the chest support 150. Such mechanisms may include, but are not limited, to a crank and pulley mechanism where the crank and pulley (not shown) may be attached to frame 110 or chest support 150. The upper body safety harness 190 may attach to the pulley, allowing safety harness 190 to shorten or lengthen as the pulley is turned.

In accordance with various embodiments of the invention and as illustrated in FIGS. 1 and 2, hand support 170 is attached to chest support 150 and is configured to provide support and comfort for the patient's hands and/or arms as the arms are draped over chest support 150.

In accordance with various embodiments of the invention and as illustrated in FIGS. 1 and 2, leg support 160 may be configured to provide support and/or comfort a patient's legs, knees, or feet. In accordance with another embodiment, leg support 160 may be configured to provide support or stabilization for various treatments. In accordance with one embodiment leg support 160 is attached to frame 110. In accordance with another embodiment leg support 160 is attached to seat 120.

Adjustment mechanisms may be located at any desired position on the body treatment system. For example, FIG. 1 illustrates an exemplary embodiment of an adjustment device 140 comprising a plurality of adjusting holes located along the adjustment device 140 attached to the back of back hold 180 which may be locked into position with a bolt, peg, latch, bracket or other fastener. As illustrated in FIG. 1, back hold 180 may be coupled to frame 110 such that back hold 180 may be adjusted vertically and/or horizontally and locked into a position (such as by adjustment device 140 or other adjustment mechanism(s)). This adjustability enables back hold 180 to target a region of interest on a patient's back, such as one or more vertebrae, to facilitate treatment. Furthermore, the back hold 180 may be oriented at any desired angle. For example, the frame of the body treatment system may be configured to allow the angle of the back hold to adjust to a desired position. For example frame 110 may pivot at pivot point 112. Moreover, back hold 180 may be any suitable size and/or shape and may be padded to comfortably contact and stabilize a region of interest.

In accordance with one embodiment, seat 120 using for example, an adjustment device 140, as illustrated in FIG. 1 is adjustable or moveable relative to frame 110 or other components of system. In the illustrated example, extending adjustment device 140 may move seat 120 closer to back hold 180 and/or chest support 150. Shortening adjustment device 140 may move seat 120 away from chest support 150 and/or back hold 180. By causing the seat to move away while a patient is secured between chest support 150 and back hold 180, a targeted portion of the patients back may be placed in traction. Adjustment device 140 may include screws, bolts, locking discs, cams, clamps, levers, rods, push pins, brackets, hydraulics, pneumatics, electromechanical device and/or any other like drive mechanisms to achieve the adjustability. An adjustment device may be operated manually or by an automated control system.

Other examples of adjustable components might include a pivot mechanism 155, which may be operable to adjust the position of the front support component 150. Hand support 170 and leg support 160 may also be configured to adjust forward, back, up, and/or down to accommodate various dimensions of the patient to, for example maximize support and/or comfort of the patient.

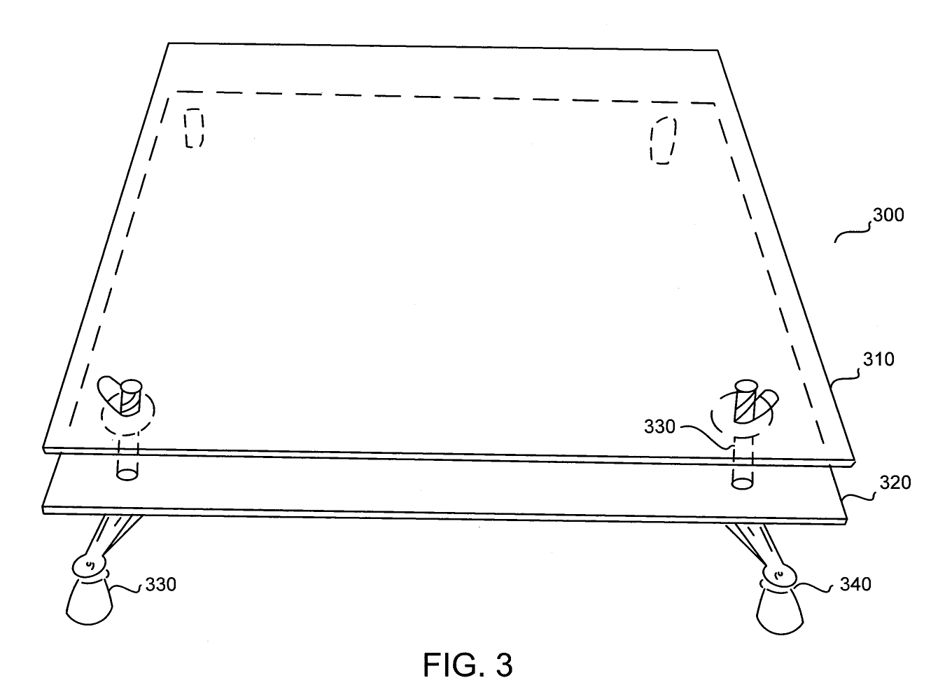

In accordance with one exemplary embodiment of the invention, various components can be internally adjustable as well. For example, FIG. 3 illustrates a seat component 300 which may include a top sheet 310 and a bottom sheet 320 coupled together by, for example, one or more actuation means (shown herein as a screw 330 and a crank 340). The illustrated example includes four actuation means, one at each corner of component 300; however, various embodiments of the invention are not limited such a configuration. In accordance with one embodiment, a corner or side of seat 300 may be manually raised or lowered relative to other corners and/or sides to the desired position. In accordance with various embodiments, the seat component may be operable (manually or automatically) to change position during treatment, thereby applying different levels of pressure to the targeted area. For example, the seat component may comprise a hydraulic device operable to adjust the position of the seat after a specified interval of time (such as every few seconds or minutes). However, it will be understood that any known means for manually or automatically raising or lowering portions of seat 300 may be used.

In accordance with various embodiments of the invention, the body treatment system may incorporate an adjustable seat such seat 300 or the body treatment system may incorporate any traditional seat known in the art. For example, seat 120 illustrated in FIG. 1 may be a traditional seat or seat 300.

Other components may be adjustable in ways similar to seat 300. For example, the back hold may include internal features (e.g. mechanical actuator and/or other adjustment mechanisms) that allow for increased adjustability to either apply better stabilization, treatment, and/or comfort.

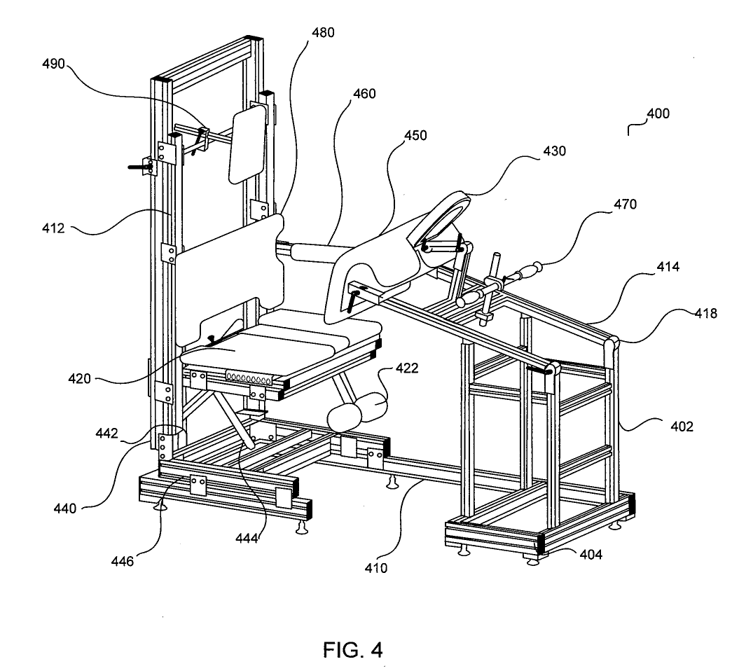

FIG. 4 illustrates a body treatment system 400 in accordance with various exemplary embodiments. Body treatment system 400 includes a frame 410 which may provide a structural base to all components of the body treatment system. In one exemplary embodiment frame 410 may support a front support assembly 414 and a back hold 490. In another embodiment frame 410 may further support a seat assembly 440. In yet another embodiment frame 410 may further support components including but not limited to a seat 420, a head support 430, a chest support 450, an arm hold 460, a back stop 480, a leg support 422, a plurality of drive mechanisms and/or vertical, horizontal, and angular adjustment assemblies.

The various components in body treatment system 400 may be the same as or similar to those of body treatment system 100 unless otherwise noted.

As illustrated in the exemplary embodiment of FIG. 4, frame 410 may comprise horizontal, vertical, and/or angular structural members. A Horizontal member 404 may be configured to provide stable contact with the floor and/or connect with feet and/or gliders that contact a floor. A vertical member 402 may be configured to provide support to various components such as for example the front support assembly 414.

In accordance with another exemplary embodiment, frame 410 may be open such that it is configured without obstruction where a patient might enter the body treatment system, thus allowing safe and easy access to system 400. Frame 410 may also be substantially open, such that the body treatment system does not interfere with comfortable positioning of the legs of a patient.

In accordance with other exemplary embodiments, again referring to FIG. 4, chair assembly 440 may support seat 420, back stop panel 480, and/or back hold 440. Alternatively and in accordance with another exemplary embodiment, back stop panel 480, and/or back hold 440 may be supported on frame 410 independent of chair assembly 440.

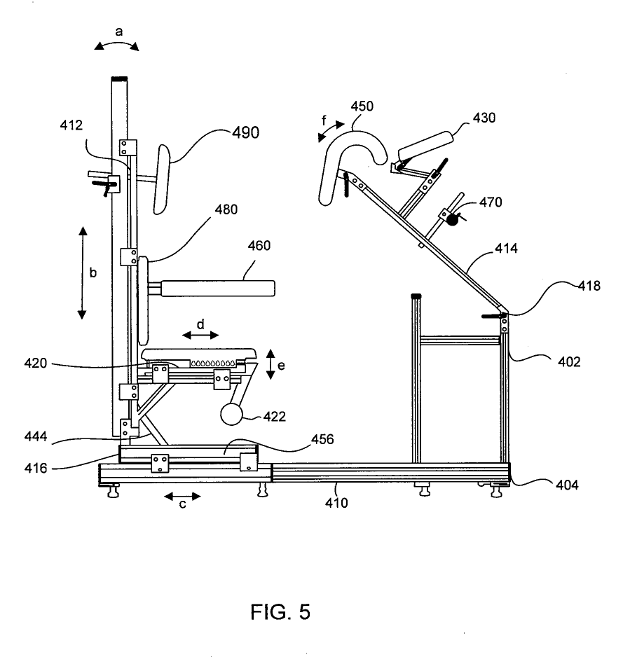

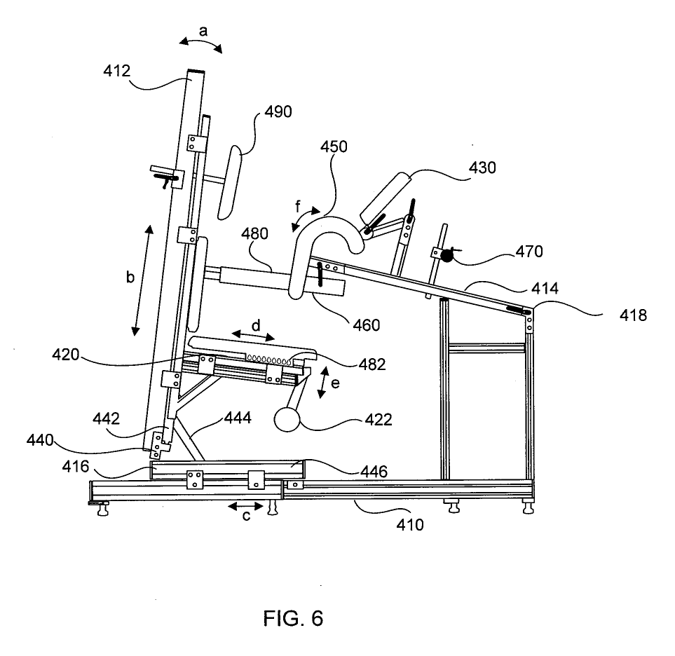

In accordance with another exemplary embodiment and referring to FIG. 4, chair assembly 440 may be integral with frame 410 or may be an adjustable attachment to frame 410. Chair assembly 440 may be adjustable vertically, horizontally, and/or angularly. In one exemplary embodiment and referring to FIG. 6 arrow b, a vertical drive mechanism 442 may extend or retract chair assembly 440 relative to the floor. In one embodiment as illustrated in FIG. 6, chair assembly 440 may extend perpendicular to a horizontal plane (i.e. the floor/ground). However with reference to FIG. 5 arrow a, angular drive mechanism 444 may also adjust the angle of chair assembly 440 relative to the horizontal plane. FIG. 6 illustrates an example of chair assembly 440 angled to the floor. Referring to FIG. 5 or FIG. 6 arrow c, horizontal movement assembly 446 may allow adjustment of chair assembly 440 parallel to the horizontal plane. Another drive mechanism may create the force to move the chair assembly in the horizontal plane.

As illustrated in FIGS. 4, 5, and 6, seat 420 may be attached to frame 410 or chair assembly 440. Chair 420 may be configured to support at least a portion of the weight of a seated patient. Chair 420 may also be independently adjustable of both frame 410 and/or chair assembly 440. Referring to FIG. 5 and FIG. 6, arrow d shows horizontal movement of seat 420 and arrow e shows vertical movement of seat 420. By allowing independent movement of seat 420, seat 420 can move after a patient has been fully seated in system 400 and is properly secured between back hold 490 and chest support 450. Moving seat 420 down and back with a patient secured between back hold 490 and chest support 450 allows the back of the patient to be put in traction and/or allow for various treatments.

As illustrated in FIGS. 4, 5, and 6, back hold 490 may be attached to frame 410 or chair assembly 440. Back hold 490 may be adjustable as part of chair assembly 440 or adjustable independently of chair assembly 440. In one embodiment and as discussed above, back hold 490 moves independently of seat 420. Back hold 490 in connection with chest support 450 may be configured to hold a patient's back in place or act as a fulcrum on a patient's back as seat 420 is moved down and back. Thus back hold 490 in connection with chest support 450 is configured to allow an appropriate hold on patient's back while final decompression is performed. Back hold 440 may also be removable to allow open access to the back of a patient during various other treatments.

In an exemplary embodiment, back stop 480 is attached to either frame 410 or chair assembly 440. Back stop 480 may be configured to provide rear support to a portion of the patient's back, hip, and/or buttock during or before treatment. In one embodiment, back stop 480 is removed after patient is secured between back hold 490 and chest support 450. By removing back stop 480 after patent is secured, more area is available for treatment.

In an exemplary embodiment, front support assembly 414 may include any combination of chest support 450, head support 530, and hand support 470. Front support assembly 414 may be attached to frame 410. In one exemplary embodiment, front support 414 may be configured to be angularly adjustable about a hinge 418 as illustrated in exemplary embodiment shown in FIG. 5 and/or FIG. 6 arrow f. In one exemplary embodiment, front support 414 may be adjustable to assure appropriate fit to a patient's chest for the proper administration of treatment. However, chair assembly 440 may also work alone or in tandem with front support 414 to assure a comfortable and appropriate fit to the patient for the proper administration of treatment.

In an exemplary embodiment, chest support 450 may be attached to either frame 410 or front support assembly 414. In one embodiment, chest support 450 may be configured to provide adequate comfort to a patient's torso during a treatment. In another embodiment, chest support 450 may be sufficiently ridged to provide necessary force to particular areas or regions of a body to accomplish various treatments.

In an exemplary embodiment, head support 430 may be attached to either frame 410 or front support assembly 414. Head support 430 may be configured to support a patient's neck, head, and/or face. In one exemplary embodiment, head support 430 may be configured to provide relaxation. In another exemplary embodiment, head support 430 may be configured to provide spine elongation.

In an exemplary embodiment, arm support 450 may be attached to the frame 410 or chair assembly 412. Arm support 450 may appear on one or both sides of seat 420. In one example, arm support 450 is configured to provide support for a patient as the patient enters or exits the system. In another exemplary embodiment the arm support feature may be configured to provide support for the patient's arms during treatment. In accordance with another exemplary embodiment, chest support 450 can be movable such that it is moved out of the way as the patient enters or exits the machine. In one example chest support 450 is attached to front assembly 414 and can be moved by swinging out of the way with front assembly 414. In another example chest support may be removably attached to front assembly 414 or frame 410 and can be removed from system 400.

In an exemplary embodiment, hand support 470 may be attached to either frame 410 or front support assembly 414. Hand support 470 may be configured to provide support and comfort to the hands and arms of the patient.

In an exemplary embodiment, leg support 422 may be attached to chair assembly 440, seat 420, or frame 410. Leg support 422 may be configured to provide support and/or comfort a patient's legs, knees, or feet. Leg support 422 may be configured to provide support or stabilization for various treatments. Leg support 422 may move with any component it is attached to for example seat 420. Alternatively leg support 422 may be removable attached to stem 400, allowing for independent removal.

As noted throughout and in accordance with various exemplary embodiments of the invention, any of a chest support 450, head support 430, hand support 470, leg support 422, seat 420, back stop 480 and/or back hold 490 may be removable from system 400, depending upon various factors, such as desired treatment and the like.

While not illustrated, system 400 may also include a lap support belt similar to lap support belt 185 illustrated in FIG. 1. System 400 may also include an adjustable quick connects 482 for adjustment of the lap support belt. Adjustable quick connect 482 allows for adjustability of a lap belt or a thigh support brace relative to seat 420. The lap support belt might be any padded or ridged bracket or belt that fits over a patient's thighs to provided added security and stabilization. System 400 may also include an upper body safety harness similar or identical to upper body safety harness 190 shown in FIG. 1 and described above. It will be understood that a body treatment system of the present invention may comprise any structure for a safety harness in any desired location and/or configuration.

As discussed above various drive mechanisms may be incorporated in various embodiment of the invention. Such drive mechanisms may include but are not limited to hydraulic, electromechanical, pneumatic, manual, or various other actuators. Each of these mechanisms may be manually triggered or may be a part of an automated control system. For example drive mechanism 444 or 442 may be pneumatic pistons, wherein the person performing the treatment has control of an actuator trigger.

In accordance with various embodiments of the present invention, a body treatment system may be used in various methods of treatments. In one embodiment, a method is performed to place targeted areas on the back of a patient in traction.

A method in accordance with various embodiments of the invention includes the steps of: positioning a patient in a sitting position within a body treatment system and then adjusting the position of one or more, in any combination, a back hold, a chair assembly, and a front assembly to the appropriate height, depth and angle to contact and target a desired region of interest on a back of a patient; and performing treatment on a patient. The treatment may comprise moving a seat down and back, so as to place the targeted area of the back in traction.

In various embodiments, a method may also include (in addition or as an alternative to any of the steps provided above) the steps of adjusting the position of one or more corners or sides of a seat component of a body treatment system, and/or adjusting the position of one or more additional support components and/or safety harnesses to a desired location to fit the patient comfortably.

In accordance with one exemplary embodiment, a method of the invention comprises the steps of positioning a patient in a standing position within a body treatment system without a seat present and then adjusting the position of a back hold, a frame, and/or a front assembly to an appropriate height, depth and angle to contact and target a desired region of interest on a back of a patient.

Attachments, connections and couplings as used herein can be accomplished by any means known in the art including but not limited to the use of various hardware and methods such as brackets, braces, hinges, adaptive components, temporary fasteners (e.g. bolts, screws, clips, pins, etc.), permanent fasteners (e.g. adhesive, weld, rivets and/or manufacture as a single piece), and/or similar means.

The terms coupled, attached and/or connected, along with their derivatives, have been used. In particular embodiments, connected may be used to indicate that two or more elements are in direct physical contact with each other. Coupled may mean that two or more elements are in direct physical contact. However, coupled may also mean that two or more elements may not be in direct contact with each other, but yet may still cooperate and/or interact with each other. Furthermore, coupled may mean that two objects are in communication with each other, and/or communicate with each other, such as two pieces of hardware. Furthermore, the term “and/or” may mean “and”, it may mean “or”, it may mean “exclusive-or”, it may mean “one”, it may mean “some, but not all”, it may mean “neither”, and/or it may mean “both”, although the scope of claimed subject matter is not limited in this respect.

It should be appreciated that the particular implementations shown and described herein are illustrative of various embodiments including its best mode, and are not intended to limit the scope of the present disclosure in any way. Furthermore, the connecting lines shown in the various figures contained herein are intended to represent exemplary functional relationships and/or physical couplings between the various elements. It should be noted that many alternative or additional functional relationships or physical connections may be present in a practical system.

It should be understood that various principles of the invention have been described in illustrative embodiments only, and that many combinations and modifications of the above-described structures, arrangements, elements, materials, components and methods used in the practice of the invention, in addition to those not specifically described, may be varied and adapted without departing from those principles.

What is claimed:

1. A body treatment system comprising:
a frame;
a seat adjustably coupled to the frame;
a back hold adjustably attached to the frame; and
a front assembly comprising a chest support attached to the frame, the chest support configured to provide support to a chest of a patient;
wherein the seat is configured to support a the patient in a seated position and wherein the back hold is configured to target and stabilize at least a portion of a back of the patient during treatment.

2. The system of claim 1, wherein the chest support is configured to at least one of support and stabilize at least a portion of a patient's chest during treatment and to allow arms of the patient to drape over the top of the chest support.

3. The system of claim 2, wherein a position of the seat is adjustable relative to the chest support.

4. The system of claim 1, further comprising a leg support configured to be adjustable, the leg support coupled to the seat.

5. The system of claim 1, further comprising an arm hold coupled to the chest support configured to support the patient.

6. The system of claim 1, further comprising a hand support coupled to the front assembly and configured to be adjustable.

7. The system of claim 1, further comprising a head support coupled to the chest support and configured for at least one of spine elongation and relaxation.

8. The system of claim 1, wherein the back support is adjustable allowing open access to the back of the patient.

9. The system of claim 8, wherein the back support is independently adjustable of the seat and chest support.

10. The system of claim 1, further comprising a lap harness coupled to the seat and configured secures the patient in the seat as the seat is adjusted.

11. The system of claim 1, wherein at least one of a seat angle, a horizontal seat position, and a vertical seat position is adjusted through a drive mechanism.

12. The system of claim 1, wherein the frame is configured without any obstruction where the patient would enter prior to sitting in the seat.

13. The system of claim 1, wherein the frame, the seat, and the back hold are configured for facilitating treatment from a sitting position

14. The system of claim 1, wherein the seat is removable, allowing treatment from a standing position.

15. A method for providing body treatment comprising:
positioning a patient within a body treatment system between a back hold and a chest support;
adjusting the position of the back hold to at least one of an appropriate height, depth and angle to contact and target a desired region of interest on a back of the patient; and
performing treatment on a patient.

16. The method of claim 15 further comprising:
adjusting an angular, a horizontal and a vertical seat position relative to the chest support and the back support while the patient is seated in the treatment system.

17. The method of claim 15 further comprising:
adjusting the position of at least on of a seat position, a chest support position, a back support position, a leg support position, a lap support, and a head support position.

18. The method of claim 16, wherein the treatment comprises moving a seat down and back while the patient is secure between the back hold and the front support.

19. A body treatment system comprising:
a frame;
a back hold coupled to the frame; and
a front assembly;
wherein the chest support is configured to provide support to a chest of a patient and wherein the back hold is configured to target and stabilize at least a portion of a back of a patient during treatment.

20. The body treatment system of claim 19, wherein the frame, the back hold, and the chest support is configured to provide treatment to a standing patient.
